(19) United States
(12) Patent Application Publication
(10) Pub. No.: US 2022/0250759 A1
(43) Pub. Date: Aug. 11, 2022

(54) FAULT-TOLERANT POWER DISTRIBUTION WITH POWER SOURCE SELECTION IN A VEHICLE

(71) Applicant: AURORA FLIGHT SCIENCES CORPORATION, A SUBSIDIARY OF THE BOEING COMPANY, Manassas, VA (US)

(72) Inventors: Wenjiang Yu, Nokesville, VA (US); James Perkinson, Winchester, MA (US)

(21) Appl. No.: 17/457,378

(22) Filed: Dec. 2, 2021

Related U.S. Application Data
(60) Provisional application No. 63/147,540, filed on Feb. 9, 2021.

(51) Int. Cl. B64D 31/00; B64D 27/24; B60L 50/00

(52) U.S. Cl. CPC B64D 31/00; B64D 27/24; B60L 2200/10; B64D 2221/00; B60L 50/00

(57) ABSTRACT

A vehicle is provided that includes a basic structure; and coupled to the basic structure, a plurality of power sources, a propulsion system and power distribution circuitry. The propulsion system includes a plurality of electric motors configured to power a plurality of propulsors to generate propulsive forces that cause the vehicle to move. The power distribution circuitry is configured to deliver direct current electric power from the plurality of power sources to the plurality of electric motors. The power distribution circuitry electrically couples the plurality of power sources to the plurality of electric motors in an interleaved topology in which electric motors of the plurality of electric motors are alternately, electrically coupled to power sources of the plurality of power sources. Each of the electric motors in the interleaved topology is electrically coupled to a different one of the power sources than immediately adjacent ones of the electric motors.

### CROSS-REFERENCE TO RELATED APPLICATION(S)

This application claims priority to U.S. Provisional Application No. 63/147,540, filed Feb. 9, 2021, entitled FAULT-TOLERANT POWER DISTRIBUTION WITH POWER SOURCE SELECTION INA VEHICLE, the content of which is incorporated herein by reference in its entirety.

### TECHNOLOGICAL FIELD

The present disclosure relates generally to electric power distribution and, in particular, to electric power distribution in electrically-powered systems such as those onboard vehicles.

### BACKGROUND

Electric and hybrid vehicles such as aerial vehicles, road vehicles and the like are powered by sources of electric power such as batteries. These vehicles generally include one or more power sources, and a propulsion system one or more electric motors configured to power one or more propulsors to generate propulsive forces that cause the vehicle to move. Depending on the vehicle, these propulsors may include rotors, propellers, wheels and the like. The propulsion system may also include a drivetrain configured to deliver power from the electric motors to the propulsors; and for some vehicles, the electric motors and drivetrain may in some contexts be referred to as the powertrain of the vehicle.

In many of these vehicles, electric power from the power sources is distributed to the electric motors via a centralized electric power distribution box designed to facilitate electric source switchover and back up in cases of certain failure modes. Existing power distribution designs usually have multiple channels of power sources, with centralized monitoring and a control unit to detect failures and control connections between sources and loads. Some design instances use additional channel via a dissimilar apparatus, and this channel is designed to have higher reliability for certain equipment such as navigation equipment in the case of air vehicles.

### BRIEF SUMMARY

As explained above, existing power distribution designs in electric and hybrid vehicles have provided back-up or failure isolation with a centralized electric power distribution box. New propulsion architectures in vehicles that use distributed propulsors driven by individual electric motors at the propulsors has provided opportunity to simplify the centralized electric power distribution box with self-arbitration between the available power sources, and improved back up and failure isolation coverage as well as propulsion system reliability.

Example implementations of the present disclosure are directed to electric power distribution and, in particular, to electric power distribution in electrically-powered systems such as those onboard vehicles. A vehicle according to some example implementations includes a plurality of power sources, and a propulsion system including a plurality of electric motors configured to power a plurality of propulsors. The vehicle also includes power distribution circuitry that electrically couples the plurality of power sources to the plurality of electric motors, such as in an interleaved topology in which electric motors of the plurality of electric motors are alternately, electrically coupled to power sources of the plurality of power sources. Example implementations employ self-control fault tolerance that selects between power sources based on their condition as operating normally or having a fault or failure.

The present disclosure thus includes, without limitation, the following example implementations.

Some example implementations provide a vehicle comprising: a basic structure; and coupled to the basic structure, a plurality of power sources; a propulsion system including a plurality of electric motors configured to power a plurality of propulsors to generate propulsive forces that cause the vehicle to move; and power distribution circuitry configured to deliver direct current (DC) electric power from the plurality of power sources to the plurality of electric motors, the power distribution circuitry electrically coupling the plurality of power sources to the plurality of electric motors in an interleaved topology in which electric motors of the plurality of electric motors are alternately, electrically coupled to power sources of the plurality of power sources, each of the electric motors electrically coupled to a different one of the power sources than immediately adjacent ones of the electric motors.

In some example implementations of the vehicle of any preceding example implementation, or any combination of any preceding example implementations, the plurality of propulsors include one or more of rotors, propellers or wheels.

In some example implementations of the vehicle of any preceding example implementation, or any combination of any preceding example implementations, each of the electric motors is electrically coupled to a different one of the power sources than the immediately adjacent ones of the electric motors in either or both direction of a pitch axis or a roll axis of the vehicle.

In some example implementations of the vehicle of any preceding example implementation, or any combination of any preceding example implementations, the basic structure includes an airframe with a fuselage and one or more pairs of wings that extend from opposing sides of the fuselage, the plurality of electric motors are mounted to the one or more pairs of wings, and each wing has multiple ones of the electric motors mounted to the wing.

In some example implementations of the vehicle of any preceding example implementation, or any combination of any preceding example implementations, the multiple ones of the electric motors include at least a first electric motor and a second electric motor electrically coupled to respectively a first and a second of the power sources.

In some example implementations of the vehicle of any preceding example implementation, or any combination of any preceding example implementations, the power distribution circuitry includes: a plurality of electric power buses electrically coupling the plurality of power sources to groups of the plurality of electric motors; a plurality of switches electrically coupled to and between the plurality of power sources and the plurality of electric power buses, the plurality of switches closed during normal operation of the plurality of power sources; one or more bus tie switches electrically coupled to and between power buses of the plurality of power sources, the one or more bus tie switches open during normal operation of the plurality of power sources; and power control circuitry configured to open one of the plurality of switches to disconnect a first of the plurality of power sources from a first of the plurality of electric power buses, and close one of the one or more bus tie switches to connect the first of the plurality of electric power buses to a second of the plurality of electric power buses, automatically in direct response to a fault or failure at the first of the plurality of power sources.

In some example implementations of the vehicle of any preceding example implementation, or any combination of any preceding example implementations, the first of the plurality of electric power buses and the second of the plurality of electric power buses electrically couples the first of the plurality of power sources and a second of the plurality of power sources to respectively first and second groups of the plurality of electric motors, and wherein the power control circuitry is configured to open the one of the plurality of switches and close the one of the one or more bus tie switches to electrically couple the second of the plurality of power sources to the first and second groups of the plurality of electric motors.

In some example implementations of the vehicle of any preceding example implementation, or any combination of any preceding example implementations, the power distribution circuitry includes: a plurality of electric power buses electrically coupling the plurality of power sources to the plurality of electric motors; and a plurality of source-selection circuitries that are separate and independent, and electrically coupled to and between the plurality of electric power buses and the plurality of electric motors, and wherein a group of the plurality of source-selection circuitries is configured to switchably connect a first of the plurality of electric power buses and thereby a first of the plurality of power sources to a first group of the plurality of electric motors during normal operation of the first of the plurality of power sources, and a second of the plurality of electric power buses and thereby a second of the plurality of power sources to the first group of the plurality of electric motors automatically in direct response to a fault or failure at the first of the plurality of power sources.

In some example implementations of the vehicle of any preceding example implementation, or any combination of any preceding example implementations, a second group of the plurality of source-selection circuitries is configured to switchably connect the second of the plurality of electric power buses to a second group of the plurality of electric motors during normal operation of the second of the plurality of power sources, and the first of the plurality of electric power buses to the second group of the plurality of electric motors automatically in direct response to the fault or failure at the second of the plurality of power sources.

In some example implementations of the vehicle of any preceding example implementation, or any combination of any preceding example implementations, the power distribution circuitry includes: a plurality of electric power buses electrically coupling the plurality of power sources to the plurality of electric motors; a plurality of source-selection circuitries that are separate and independent, and electrically coupled to and between the plurality of power sources and the plurality of electric power buses, and wherein a source-selection circuitry of the plurality of source-selection circuitries is configured to switchably connect a first of the plurality of power sources to a first of the plurality of electric power buses during normal operation of the first of the plurality of power sources, and a second of the plurality of power sources to the first of the plurality of electric power buses automatically in direct response to a fault or failure at the first of the plurality of power sources.

In some example implementations of the vehicle of any preceding example implementation, or any combination of any preceding example implementations, a second source-selection circuitry of the plurality of source-selection circuitries is configured to switchably connect the second of the plurality of power sources to the second of the plurality of electric power buses during normal operation of the second of the plurality of power sources, and the first of the plurality of power sources to the second of the plurality of electric power buses automatically in direct response to the fault or failure at the second of the plurality of power sources.

In some example implementations of the vehicle of any preceding example implementation, or any combination of any preceding example implementations, the power distribution circuitry includes: a plurality of electric power buses with a plurality of feeders electrically coupling the plurality of power sources to the plurality of electric motors; and a plurality of interlocks electrically coupled to and between the plurality of feeders across the plurality of electric power buses, including interlocks configured to electrically couple feeders of a first of the plurality of electric power buses to different feeders of different ones of others of the plurality of electric power buses, automatically and in direct response to a fault or failure at a first of the plurality of power sources electrically coupled to the first of the plurality of electric power buses.

In some example implementations of the vehicle of any preceding example implementation, or any combination of any preceding example implementations, the interlocks include switches that are open during normal operation of the plurality of power sources, and the interlocks are configured to close a first of the switches to connect a first feeder of the first of the plurality of electric power buses and one of the feeders of a second of the plurality of electric power buses, and close a second of the switches to connect a second feeder of the first of the plurality of electric power buses and one of the feeders of a third of the plurality of electric power buses.

Some example implementations provide a method of managing power in a vehicle, the method comprising: providing the vehicle including a plurality of power sources, a propulsion system including a plurality of electric motors configured to power a plurality of propulsors to generate propulsive forces that cause the vehicle to move, and power distribution circuitry; and delivering direct current (DC) electric power from the plurality of power sources to the plurality of electric motors via the power distribution circuitry electrically coupling the plurality of power sources to the plurality of electric motors in an interleaved topology in which electric motors of the plurality of electric motors are alternately, electrically coupled to power sources of the plurality of power sources, each of the electric motors electrically coupled to a different one of the power sources than immediately adjacent ones of the electric motors.

In some example implementations of the method of any preceding example implementation, or any combination of any preceding example implementations, delivering the DC electric power includes delivering the DC electric power via the power distribution circuitry in which each of the electric motors is electrically coupled to a different one of the power sources than the immediately adjacent ones of the electric motors in either or both direction of a pitch axis or a roll axis of the vehicle.

In some example implementations of the method of any preceding example implementation, or any combination of any preceding example implementations, providing the vehicle includes providing the vehicle further including an airframe with a fuselage and one or more pairs of wings that extend from opposing sides of the fuselage, the plurality of electric motors are mounted to the one or more pairs of wings, and each wing has multiple ones of the electric motors mounted to the wing.

In some example implementations of the method of any preceding example implementation, or any combination of any preceding example implementations, delivering the DC electric power includes delivering the DC electric power via the power distribution circuitry in which the multiple ones of the electric motors include at least a first electric motor and a second electric motor electrically coupled to respectively a first and a second of the power sources.

In some example implementations of the method of any preceding example implementation, or any combination of any preceding example implementations, the power distribution circuitry includes a plurality of electric power buses electrically coupling the plurality of power sources to groups of the plurality of electric motors, a plurality of switches electrically coupled to and between the plurality of power sources and the plurality of electric power buses, and one or more bus tie switches electrically coupled to and between power buses of the plurality of power sources, the plurality of switches and the one or more bus tie switches respectively closed and open during normal operation of the plurality of power sources, and wherein the method further comprises opening one of the plurality of switches to disconnect a first of the plurality of power sources from a first of the plurality of electric power buses, and closing one of the one or more bus tie switches to connect the first of the plurality of electric power buses to a second of the plurality of electric power buses, automatically in direct response to a fault or failure at the first of the plurality of power sources.

In some example implementations of the method of any preceding example implementation, or any combination of any preceding example implementations, the first of the plurality of electric power buses and the second of the plurality of electric power buses electrically couples the first of the plurality of power sources and a second of the plurality of power sources to respectively first and second groups of the plurality of electric motors, and wherein the one of the plurality of switches is opened, and the one of the one or more bus tie switches is closed, to electrically couple the second of the plurality of power sources to the first and second groups of the plurality of electric motors.

In some example implementations of the method of any preceding example implementation, or any combination of any preceding example implementations, the power distribution circuitry includes a plurality of electric power buses electrically coupling the plurality of power sources to the plurality of electric motors, and a plurality of source-selection circuitries that are separate and independent, and electrically coupled to and between the plurality of electric power buses and the plurality of electric motors, and wherein the method further comprises a group of the plurality of source-selection circuitries switchably connecting a first of the plurality of electric power buses and thereby a first of the plurality of power sources to a first group of the plurality of electric motors during normal operation of the first of the plurality of power sources, and a second of the plurality of electric power buses and thereby a second of the plurality of power sources to the first group of the plurality of electric motors automatically in direct response to a fault or failure at the first of the plurality of power sources.

In some example implementations of the method of any preceding example implementation, or any combination of any preceding example implementations, the method further comprises a second group of the plurality of source-selection circuitries switchably connecting the second of the plurality of electric power buses to a second group of the plurality of electric motors during normal operation of the second of the plurality of power sources, and the first of the plurality of electric power buses to the second group of the plurality of electric motors automatically in direct response to the fault or failure at the second of the plurality of power sources.

In some example implementations of the method of any preceding example implementation, or any combination of any preceding example implementations, the power distribution circuitry includes a plurality of electric power buses electrically coupling the plurality of power sources to the plurality of electric motors, and a plurality of source-selection circuitries that are separate and independent, and electrically coupled to and between the plurality of power sources and the plurality of electric power buses, and wherein the method further comprises a source-selection circuitry of the plurality of source-selection circuitries switchably connecting a first of the plurality of power sources to a first of the plurality of electric power buses during normal operation of the first of the plurality of power sources, and a second of the plurality of power sources to the first of the plurality of electric power buses automatically in direct response to a fault or failure at the first of the plurality of power sources.

In some example implementations of the method of any preceding example implementation, or any combination of any preceding example implementations, the method further comprises a second source-selection circuitry of the plurality of source-selection circuitries switchably connecting the second of the plurality of power sources to the second of the plurality of electric power buses during normal operation of the second of the plurality of power sources, and the first of the plurality of power sources to the second of the plurality of electric power buses automatically in direct response to the fault or failure at the second of the plurality of power sources.

In some example implementations of the method of any preceding example implementation, or any combination of any preceding example implementations, the power distribution circuitry includes a plurality of electric power buses with a plurality of feeders electrically coupling the plurality of power sources to the plurality of electric motors, and a plurality of interlocks electrically coupled to and between the plurality of feeders across the plurality of electric power buses, and wherein the method further comprises interlocks of the plurality of interlocks electrically coupling feeders of a first of the plurality of electric power buses to different feeders of different ones of others of the plurality of electric power buses, automatically and in direct response to a fault or failure at a first of the plurality of power sources electrically coupled to the first of the plurality of electric power buses.

In some example implementations of the method of any preceding example implementation, or any combination of any preceding example implementations, the interlocks include switches that are open during normal operation of the plurality of power sources, and wherein the interlocks electrically coupling the feeders includes the interlocks closing a first of the switches to connect a first feeder of the first of the plurality of electric power buses and one of the feeders of a second of the plurality of electric power buses, and closing a second of the switches to connect a second feeder of the first of the plurality of electric power buses and one of the feeders of a third of the plurality of electric power buses.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIGS. 1A and 1B illustrate one type of vehicle, namely, an aircraft, according to example implementations of the present disclosure;

FIGS. 2, 3, 4 and 5 illustrate power distribution circuitry, according to various example implementations; and

FIGS. 6A, 6B, 6C, 6D, 6E, 6F and 6G are flowcharts illustrating various steps in a method of managing power in a vehicle, according to various example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably.

Example implementations of the present disclosure relate generally to electric power distribution and, in particular, to electric power distribution in electrically-powered systems such as those onboard vehicles. As used herein, a vehicle is a machine designed as an instrument of conveyance by land, water or air. A vehicle designed and configurable to fly may at times be referred to as an aerial vehicle or aircraft. A vehicle designed and configurable to operate with at least some level of autonomy may at times be referred to as an autonomous vehicle, or an autonomous aerial vehicle or aircraft in the case of an autonomous vehicle that is also designed and configurable to fly. Other examples of suitable vehicles include a variety of road vehicles, railed vehicles, watercraft (surface vessels, underwater vessels), amphibious vehicles, spacecraft and the like. In some examples, the vehicle is an electric vehicle such as an electric road or rail vehicle, an electric aircraft, an electric spacecraft or the like.

The vehicle may be manned or unmanned. The vehicle may be fully human-controlled, or the vehicle may be semi-autonomous or autonomous in which at least some of its maneuvers are executed independent of or with minimal human intervention. In some examples, the vehicle is operable in various modes with various amounts of human control.

A vehicle generally includes a basic structure; and coupled to the basic structure, a power source, power distribution circuitry and a propulsion system. The basic structure is the main supporting structure of the vehicle to which other components are attached. The basic structure is the load-bearing framework of the vehicle that structurally supports the vehicle in its construction and function. In various contexts, the basic structure may be referred to as a chassis, an airframe or the like.

The power source is a source of power such as electric power from which the vehicle is powered to move; and in some examples, the vehicle includes multiple or a plurality of power sources. Examples of suitable power sources include batteries, solar panels, fuel cells, electric generators and the like. The power distribution circuitry includes power transmission lines, power electronics and other circuitry for distribution of power from the power source to an electrical load such as the propulsion system and other onboard electronics.

The propulsion system includes one or more electric motors configured to power one or more propulsors to generate propulsive forces that cause the vehicle to move. Although not separately shown, in some examples, one or more motor controllers may be included to coordinate performance of the one or more electric motors. A propulsor is any of a number of different means of converting power into a propulsive force. Examples of suitable propulsors include rotors, propellers, wheels and the like. In some examples, the propulsion system includes a drivetrain configured to deliver power from the electric motors to the propulsors. The electric motors and drivetrain may in some contexts be referred to as the powertrain of the vehicle.

The vehicle may also include any of a number of other systems, subsystems, components and the like. In particular, for example, the vehicle may include a vehicle management system (VMS). The VMS is a vehicle-specific subsystem configured to manage subsystems and other components of the vehicle. These subsystems and other components include, for example, maneuver controls, landing gear, onboard environmental systems, electrical, pneumatic and hydraulic systems, communications systems, navigation systems and other subsystems and components for controlling operation and maneuvering of the vehicle. The VMS is configured to accept maneuver commands such as waypoints and/or steering commands, and control the vehicle to follow those maneuver commands.

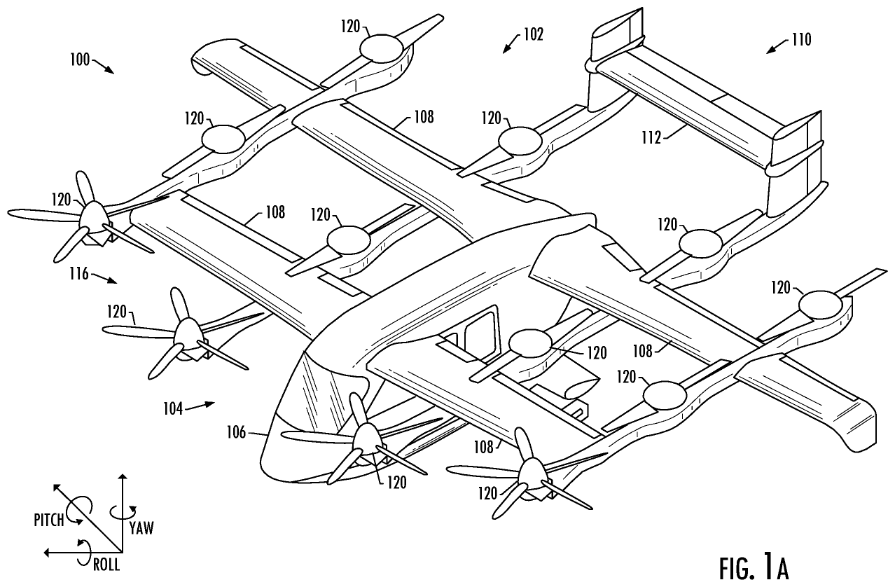

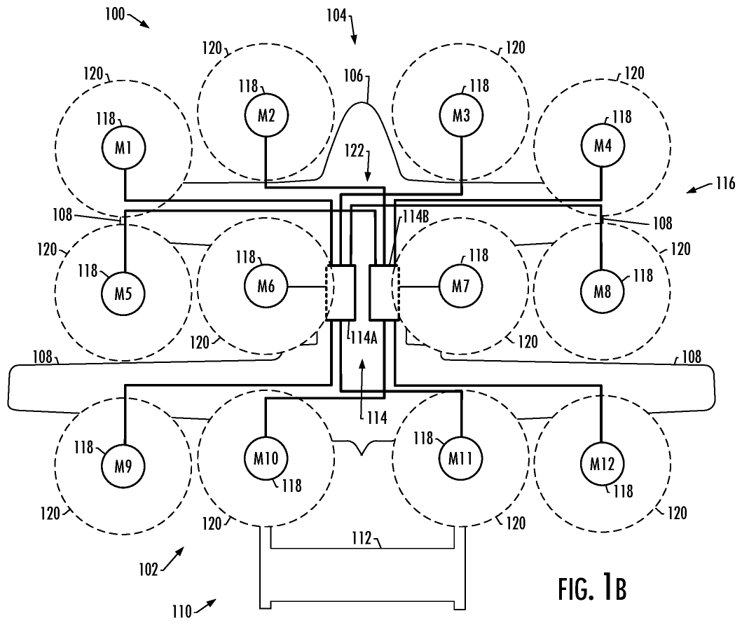

FIGS. 1A and 1B illustrate one type of vehicle 100, namely, an aircraft, that may benefit from example implementations of the present disclosure. As shown, the vehicle generally includes a basic structure 102 with an airframe 104 with including a fuselage 106, and one or more pairs of wings 108 that extend from opposing sides of the fuselage. The airframe also includes an empennage or tail assembly 110 at a rear end of the fuselage, and the tail assembly includes a stabilizer 112.

The vehicle 100 includes a plurality of power sources 114, and a propulsion system 116 including a plurality of electric motors 118 configured to power a plurality of propulsors 120 to generate propulsive forces that cause the vehicle to move. The vehicle as shown includes twelve electric motors (labeled M1-M12), and the propulsors are rotors. Depending on the vehicle, in various examples, the propulsors include one or more of rotors, propellers or wheels. Also in the vehicle as shown, the plurality of electric motors are mounted to the one or more pairs of wings 108, and each wing has multiple ones of the electric motors mounted to the wing. As also shown, power distribution circuitry 122 electrically couples the plurality of power sources to the plurality of electric motors. The power distribution circuitry is configured to deliver electric power from the plurality of power sources to the plurality of electric motors.

As shown more particularly in FIG. 1B, according to some example implementations of the present disclosure, the power distribution circuitry 122 electrically couples the plurality of power sources 114 to the plurality of electric motors 118 in an interleaved topology. In some examples of this topology, electric motors of the plurality of electric motors are alternately, electrically coupled to power sources of the plurality of power sources. Each of the electric motors is electrically coupled to a different one of the power sources than immediately adjacent ones of the electric motors. In some examples, each of the electric motors is electrically coupled to a different one of the power sources than the immediately adjacent ones of the electric motors in either or both direction of a pitch axis or a roll axis of the vehicle.

The interleaved topology in which the power distribution circuitry 122 electrically couples the plurality of power sources 114 to the plurality of electric motors 118 may be implemented in a number of different manners depending on the need or role of the electric motors. In the vehicle 100 as shown, the first row of propulsors 120 are tilted relative to the other rows of propulsors. The first row of propulsors is primarily responsible for transition and forward flight (i.e., forward thrust). Higher redundancy may be required for the first row of propulsors relative to the other rows of propulsors. In other configurations, the electrical coupling may be distributed in a different manner or level.

In some examples in which the vehicle 100 is an aircraft, the plurality of electric motors 118 are mounted to the one or more pairs of wings 108, and each wing has multiple ones of the electric motors mounted to the wing. In some of these examples, the multiple ones of the electric motors include at least a first electric motor and a second electric motor electrically coupled to respectively a first and a second of the power sources 114A, 114B. As shown, in particular, the multiple ones of the electric motors may include first electric motors M1, M3, M6, M8, M9, M11, and second electric motors M2, M4, M5, M7, M10, M12 electrically coupled to respectively the first and the second of the power sources.

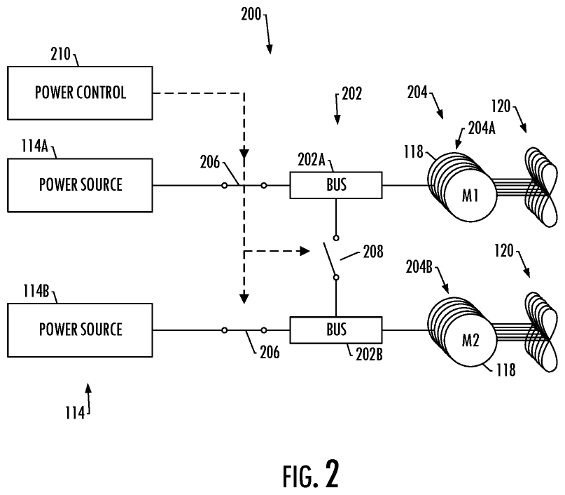

FIGS. 2, 3, 4 and 5 illustrate power distribution circuitry that in various example implementations may correspond to the power distribution circuitry 122 shown in FIGS. 1A and 1B. The power distribution circuitry is shown and described herein in the context of a vehicle including a number of power sources, electric motors and propulsors. The numbers of these and other components shown in the figures are provided by way of example and should not be taken as limiting. The power distribution circuitry according to the various example implementations may electrically couple any number of power sources to any number of electric motors, according to example implementations of the present disclosure.

FIG. 2 illustrates power distribution circuitry 200 according to some example implementations. As shown, the power distribution circuitry 200 includes a plurality of electric power buses 202 electrically coupling the plurality of power sources 114 to groups 204 of the plurality of electric motors 118. The power distribution circuitry includes a plurality of switches 206 electrically coupled to and between the plurality of power sources and the plurality of electric power buses, and one or more bus tie switches 208 electrically coupled to and between power buses of the plurality of power sources. The plurality of switches are closed during normal operation of the plurality of power sources, and the one or more bus tie switches are open during normal operation of the plurality of power sources.

As also shown, the power distribution circuitry includes power control circuitry 210 configured to control the plurality of switches 206 and the one or more bus tie switches 208 based on conditions of the plurality of power sources 114. Although not separately shown, the power control circuitry may include bus sensing circuitry, which may be implemented in a number of different manners. The bus sensing circuitry may be implemented using relays to sense input states of the plurality of power sources, and control the plurality of switches and the one or more bus tie switches. Other examples include sensing the input states of the plurality of power sources with voltage transducers, controlling the plurality of switches and the one or more bus tie switches with solid-state switches, and the like.

According to some example implementations, the power control circuitry 210 is configured to open one of the plurality of switches 206 to disconnect a first of the plurality of power sources 114A from a first of the plurality of electric power buses 202A, and close one of the one or more bus tie switches 208 to connect the first of the plurality of electric power buses to a second of the plurality of electric power buses 202B. In this regard, the power control circuitry is configured to open and close the respective switches, automatically in direct response to a fault or failure at the first of the plurality of power sources.

In some further examples, the first of the plurality of electric power buses 202A and the second of the plurality of electric power buses 202B electrically couple the first of the plurality of power sources 114A and a second of the plurality of power sources 114B to respectively first and second groups 204A, 204B of the plurality of electric motors 118. In some of these examples, the power control circuitry 210 is configured to open the one of the plurality of switches 206 and close the one of the one or more bus tie switches 208 to electrically couple the second of the plurality of power sources to the first and second groups of the plurality of electric motors.

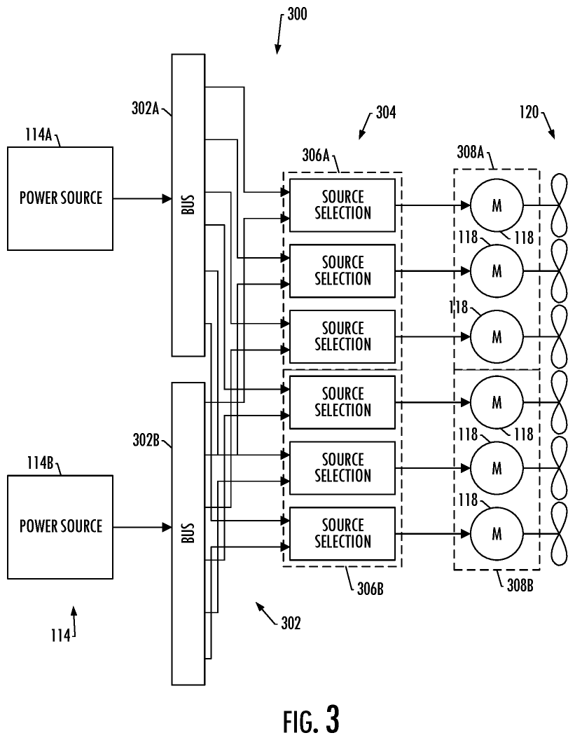

FIG. 3 illustrates power distribution circuitry 300 according to other example implementations. As shown, the power distribution circuitry 300 includes a plurality of electric power buses 302 electrically coupling the plurality of power sources 114 to the plurality of electric motors 118. The power distribution circuitry includes a plurality of source-selection circuitries 304 that are separate and independent, and electrically coupled to and between the plurality of electric power buses and the plurality of electric motors.

According to some implementations, a group 306A of the plurality of source-selection circuitries 304 is configured to switchably connect a first or a second of the plurality of electric power buses 302A, 302B, and thereby a first or a second of the plurality of power sources 114A, 114B, to a first group 308A of the plurality of electric motors 118 based on conditions of the plurality of power sources 114. In this regard, in some examples, the plurality of source-selection circuitries is configured to connect the first of the plurality of electric power buses, and thereby the first of the plurality of power sources, to the first group of the plurality of electric motors during normal operation of the first of the plurality of power sources. The plurality of source-selection circuitries is configured to connect the second of the plurality of electric power buses, and thereby the second of the plurality of power sources, to the first group of the plurality of electric motors automatically in direct response to a fault or failure at the first of the plurality of power sources.

In some further examples, a second group 306B of the plurality of source-selection circuitries 304 is configured to switchably connect the first or the second of the plurality of electric power buses 302A, 302B, and thereby the first or a second of the plurality of power sources 114A, 114B, to a second group 308B of the plurality of electric motors 118 based on conditions of the plurality of power sources 114. The second group of the plurality of source-selection circuitries is configured to connect the second of the plurality of electric power buses to the second group of the plurality of electric motors during normal operation of the second of the plurality of power sources. The second group of the plurality of source-selection circuitries is configured to connect the first of the plurality of electric power buses to the second group of the plurality of electric motors automatically in direct response to the fault or failure at the second of the plurality of power sources.

FIG. 4 illustrates power distribution circuitry 400 according to yet other example implementations. As shown, the power distribution circuitry 400 includes a plurality of electric power buses 402 electrically coupling the plurality of power sources 114 to the plurality of electric motors 118. The power distribution circuitry includes a plurality of source-selection circuitries 404 that are separate and independent, and electrically coupled to and between the plurality of power sources and the plurality of electric power buses.

According to some of these examples, a source-selection circuitry 404A of the plurality of source-selection circuitries 404 is configured to switchably connect a first or a second of the plurality of power sources 114A, 114B to a first of the plurality of electric power buses 402A based on a condition of the first of the plurality of power sources. The source-selection circuitry is configured to connect the first of the plurality of power sources to the first of the plurality of electric power buses during normal operation of the first of the plurality of power sources. The source-selection circuitry is configured to connect the second of the plurality of power sources to the first of the plurality of electric power buses automatically in direct response to a fault or failure at the first of the plurality of power sources.

In some further examples, a second source-selection circuitry 404B of the plurality of source-selection circuitries 404 is configured to switchably connect a first or a second of the plurality of power sources 114A, 114B to a second of the plurality of electric power buses 402B based on a condition of the second of the plurality of power sources. The second source-selection circuitry is configured to connect the second of the plurality of power sources to the second of the plurality of electric power buses during normal operation of the second of the plurality of power sources. And the second source-selection circuitry is configured to connect the first of the plurality of power sources to the second of the plurality of electric power buses automatically in direct response to the fault or failure at the second of the plurality of power sources.

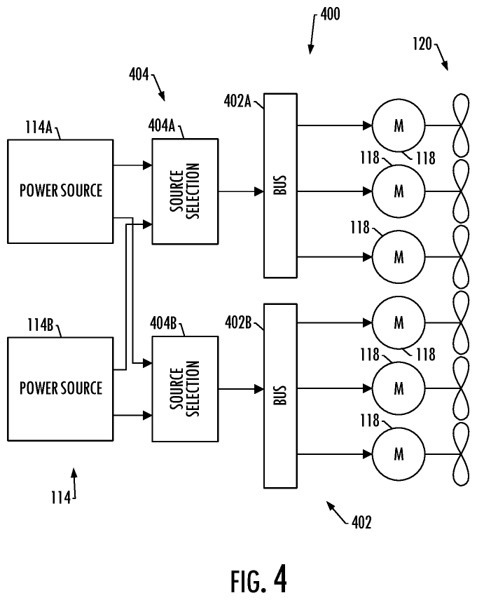

FIG. 5 illustrates power distribution circuitry 500 according to some example implementations. As shown, the power distribution circuitry 500 includes a plurality of electric power buses 502 with a plurality of feeders 504 electrically coupling the plurality of power sources 114 to the plurality of electric motors 118. The power distribution circuitry also includes a plurality of interlocks 506 electrically coupled to and between the plurality of feeders across the plurality of electric power buses. This includes interlocks configured to electrically couple feeders of a first of the plurality of electric power buses 502A to different feeders of different ones of others of the plurality of electric power buses 502B, 502C, automatically and in direct response to a fault or failure at a first of the plurality of power sources 114A electrically coupled to the first of the plurality of electric power buses.

In some further examples, the interlocks include switches 508 that are open during normal operation of the plurality of power sources 114. In some of these examples, the interlocks are configured to close a first of the switches 508A to connect a first feeder 504A of the first of the plurality of electric power buses 502A and one of the feeders 504C of a second of the plurality of electric power buses 502B. Likewise, the interlocks are configured to close a second of the switches 508B to connect a second feeder 504B of the first of the plurality of electric power buses and one of the feeders 504D of a third of the plurality of electric power buses 502C.

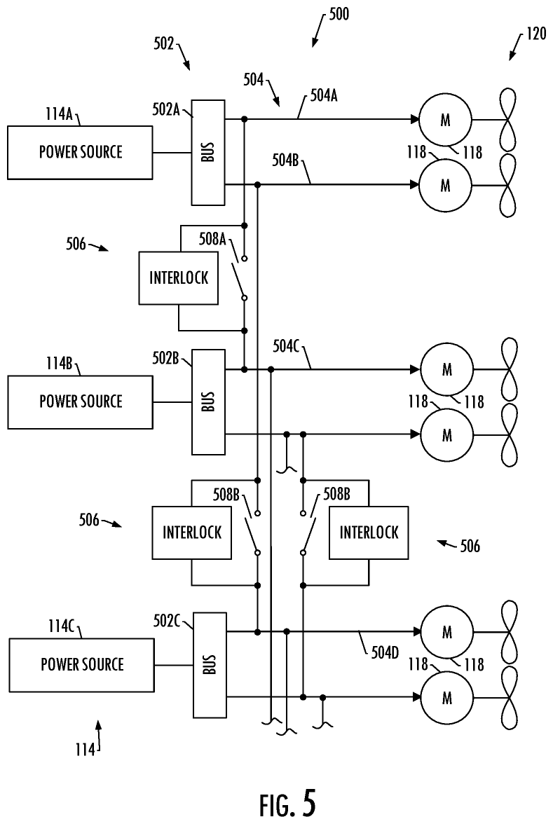

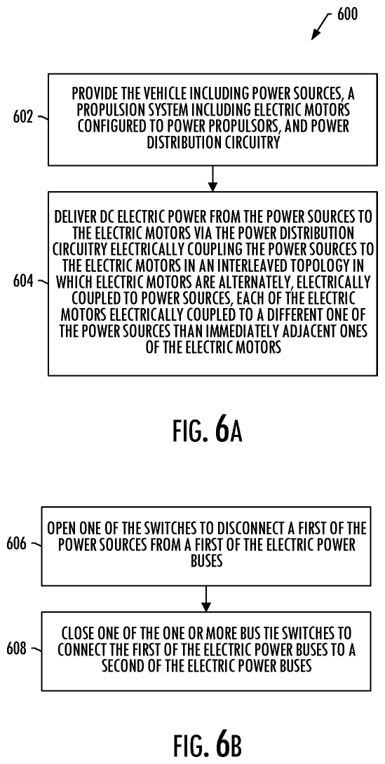

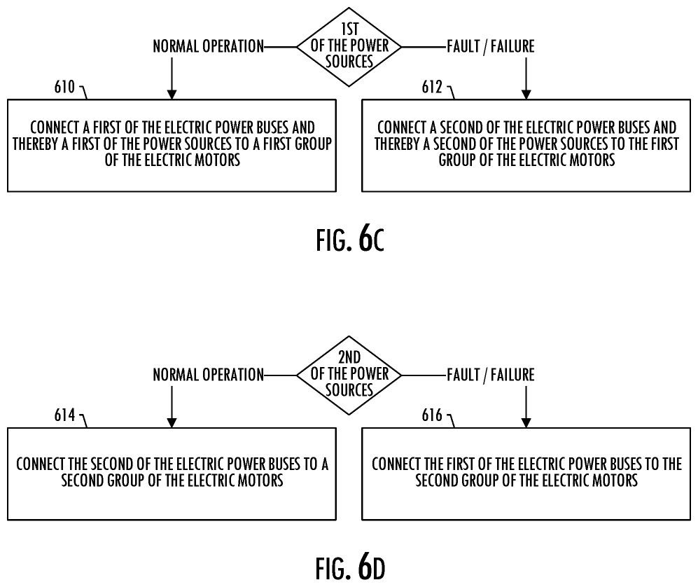

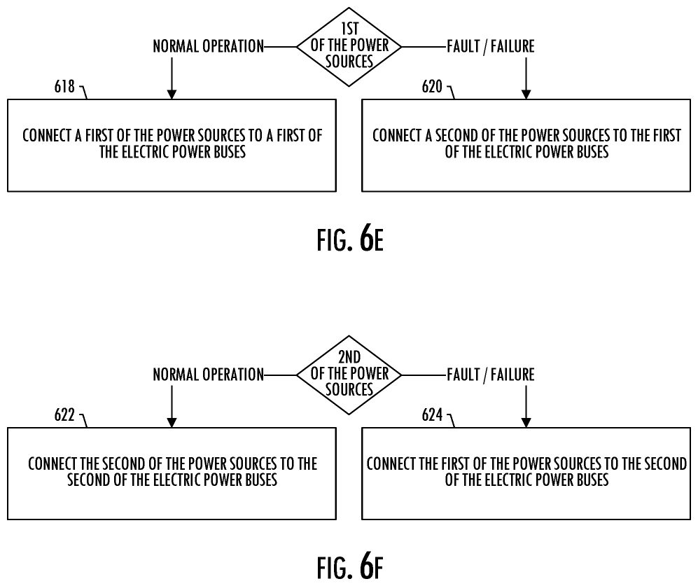

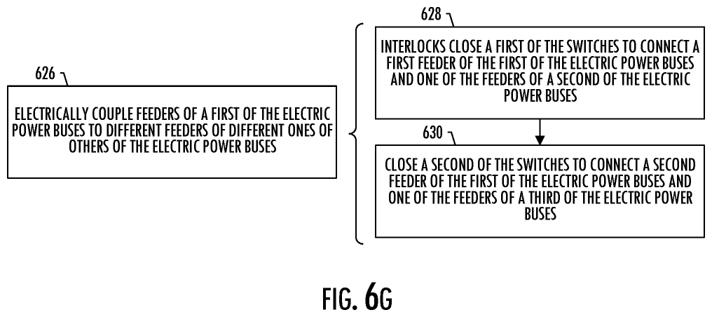

FIGS. 6A-6G are flowcharts illustrating various steps in a method 600 of managing power in a vehicle 100, according to various example implementations. The method includes providing the vehicle including a plurality of power sources 114, a propulsion system 116 including a plurality of electric motors 118 configured to power a plurality of propulsors 120 to generate propulsive forces that cause the vehicle to move, and power distribution circuitry 122, as shown at block 602 of FIG. 6A. The method also includes delivering direct current DC electric power from the plurality of power sources to the plurality of electric motors via the power distribution circuitry electrically coupling the plurality of power sources to the plurality of electric motors in an interleaved topology, as shown at block 604. Again, in this topology, which electric motors of the plurality of electric motors are alternately, electrically coupled to power sources of the plurality of power sources, each of the electric motors electrically coupled to a different one of the power sources than immediately adjacent ones of the electric motors.

In some examples, delivering the DC electric power at block 604 includes delivering the DC electric power via the power distribution circuitry 122 in which each of the electric motors 118 is electrically coupled to a different one of the power sources 114 than the immediately adjacent ones of the electric motors in either or both direction of a pitch axis or a roll axis of the vehicle 100.

In some examples, providing the vehicle 100 at block 602 includes providing the vehicle further including an airframe 104 with a fuselage 106 and one or more pairs of wings 108 that extend from opposing sides of the fuselage. In some of these examples, the plurality of electric motors 118 are mounted to the one or more pairs of wings, and each wing has multiple ones of the electric motors mounted to the wing.

In some examples, delivering the DC electric power at block 604 includes delivering the DC electric power via the power distribution circuitry 122 in which the multiple ones of the electric motors 118 include at least a first electric motor (e.g., M1, M3, M6, M8, M9, M11) and a second electric motor (e.g., M2, M4, M5, M7, M10, M12) electrically coupled to respectively a first and a second of the power sources 114A, 114B.

In some examples, the power distribution circuitry 122, 200 includes a plurality of electric power buses 202 electrically coupling the plurality of power sources 114 to groups 204 of the plurality of electric motors 118. The power distribution circuitry also includes a plurality of switches 206 electrically coupled to and between the plurality of power sources and the plurality of electric power buses, and one or more bus tie switches 208 electrically coupled to and between power buses of the plurality of power sources. The plurality of switches and the one or more bus tie switches respectively closed and open during normal operation of the plurality of power sources.

Also in some of these examples, the method 600 further includes opening one of the plurality of switches to disconnect a first of the plurality of power sources 114A from a first of the plurality of electric power buses 202A, as shown at block 606 of FIG. 6B. The method also includes closing one of the one or more bus tie switches to connect the first of the plurality of electric power buses to a second of the plurality of electric power buses 202B, automatically in direct response to a fault or failure at the first of the plurality of power sources, as shown at block 608.

In some further examples, the first of the plurality of electric power buses 202A and the second of the plurality of electric power buses 202B electrically couples the first of the plurality of power sources 114A and a second of the plurality of power sources 114B to respectively first and second groups 204A, 204B of the plurality of electric motors 118. In some of these examples, the one of the plurality of switches is opened at block 606, and the one of the one or more bus tie switches is closed at block 608, to electrically couple the second of the plurality of power sources to the first and second groups of the plurality of electric motors.

In some examples, the power distribution circuitry 122, 300 includes a plurality of electric power buses 302 electrically coupling the plurality of power sources 114 to the plurality of electric motors 118. The power distribution circuitry also includes a plurality of source-selection circuitries 304 that are separate and independent, and electrically coupled to and between the plurality of electric power buses and the plurality of electric motors.

Also in some of these examples, the method 600 further includes a group 306A of the plurality of source-selection circuitries switchably connecting a first or a second of the plurality of electric power buses 302A, and thereby a first or a second of the plurality of power sources 114A, to a first group 308A of the plurality of electric motors, as shown at blocks 610 and 612 of FIG. 6C. The group of the plurality of source-selection circuitries connect the first of the plurality of electric power buses (and thereby the first of the plurality of power sources) to the first group of the plurality of electric motors during normal operation of the first of the plurality of power sources. And the group of the plurality of source-selection circuitries connect the second of the plurality of electric power buses (and thereby the second of the plurality of power sources) to the first group of the plurality of electric motors automatically in direct response to a fault or failure at the first of the plurality of power sources.

In some further examples, the method 600 further includes a second group 306B of the plurality of source-selection circuitries switchably connecting the first or the second of the plurality of electric power buses 302A, and thereby the first or the second of the plurality of power sources 114A, to a first group 308A of the plurality of electric motors, as shown at blocks 614 and 616 of FIG. 6D. The second group of the plurality of source-selection circuitries connect the second of the plurality of electric power buses (and thereby the second of the plurality of power sources) to the second group of the plurality of electric motors during normal operation of the second of the plurality of power sources. And the second group of the plurality of source-selection circuitries connect the first of the plurality of electric power buses (and thereby the first of the plurality of power sources) to the second group of the plurality of electric motors automatically in direct response to a fault or failure at the second of the plurality of power sources.

In some examples, the power distribution circuitry 122, 400 includes a plurality of electric power buses 402 electrically coupling the plurality of power sources 114 to the plurality of electric motors 118. The power distribution circuitry also includes a plurality of source-selection circuitries 404 that are separate and independent, and electrically coupled to and between the plurality of power sources and the plurality of electric power buses.

The method 600 in some of these examples further includes a source-selection circuitry 404A of the plurality of source-selection circuitries 404 switchably connecting a first or a second of the plurality of power sources 114A, 114B to a first of the plurality of electric power buses 402A, as shown at blocks 618 and 620 of FIG. 6E. The source-selection circuitry connects the first of the plurality of power sources to the first of the plurality of electric power buses during normal operation of the first of the plurality of power sources. And the source-selection circuitry connects the second of the plurality of power sources to the first of the plurality of electric power buses automatically in direct response to a fault or failure at the first of the plurality of power sources.

In some further examples, the method 600 further includes a second source-selection circuitry 404B of the plurality of source-selection circuitries 404 switchably connecting the first or the second of the plurality of power sources 114A, 114B to a second of the plurality of electric power buses 402B, as shown at blocks 622 and 624 of FIG. 6F. The second source-selection circuitry connects the second of the plurality of power sources to the second of the plurality of electric power buses during normal operation of the second of the plurality of power sources. And the second source-selection circuitry connects the first of the plurality of power sources to the second of the plurality of electric power buses automatically in direct response to a fault or failure at the second of the plurality of power sources.

In some examples, the power distribution circuitry 122, 500 includes a plurality of electric power buses 502 with a plurality of feeders 504 electrically coupling the plurality of power sources 114 to the plurality of electric motors 118, and a plurality of interlocks 506 electrically coupled to and between the plurality of feeders across the plurality of electric power buses. In some of these examples, the method 600 further includes interlocks of the plurality of interlocks electrically coupling feeders of a first of the plurality of electric power buses 502A to different feeders of different ones of others of the plurality of electric power buses 502B, 502C, automatically and in direct response to a fault or failure at a first of the plurality of power sources 114A electrically coupled to the first of the plurality of electric power buses, as shown at block 626 of FIG. 6G

In some further examples, the interlocks include switches 508 that are open during normal operation of the plurality of power sources 114. In some of these examples, the interlocks electrically coupling the feeders at block 626 includes the interlocks closing a first of the switches 508A to connect a first feeder 504A of the first of the plurality of electric power buses 502A and one of the feeders 504C of a second of the plurality of electric power buses 502B, as shown at block 628. The interlocks also close a second of the switches 508B to connect a second feeder 504B of the first of the plurality of electric power buses and one of the feeders 504D of a third of the plurality of electric power buses 502C, as shown at block 630.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A vehicle comprising:
a basic structure; and coupled to the basic structure,
a plurality of power sources;
a propulsion system including a plurality of electric motors configured to power a plurality of propulsors to generate propulsive forces that cause the vehicle to move; and
power distribution circuitry configured to deliver direct current (DC) electric power from the plurality of power sources to the plurality of electric motors, the power distribution circuitry electrically coupling the plurality of power sources to the plurality of electric motors in an interleaved topology in which electric motors of the plurality of electric motors are alternately, electrically coupled to power sources of the plurality of power sources, each of the electric motors electrically coupled to a different one of the power sources than immediately adjacent ones of the electric motors.

2. The vehicle of claim 1, wherein the plurality of propulsors include one or more of rotors, propellers or wheels.

3. The vehicle of claim 1, wherein each of the electric motors is electrically coupled to a different one of the power sources than the immediately adjacent ones of the electric motors in either or both direction of a pitch axis or a roll axis of the vehicle.

4. The vehicle of claim 1, wherein the basic structure includes an airframe with a fuselage and one or more pairs of wings that extend from opposing sides of the fuselage, the plurality of electric motors are mounted to the one or more pairs of wings, and each wing has multiple ones of the electric motors mounted to the wing.

5. The vehicle of claim 4, wherein the multiple ones of the electric motors include at least a first electric motor and a second electric motor electrically coupled to respectively a first and a second of the power sources.

6. The vehicle of claim 1, wherein the power distribution circuitry includes:
a plurality of electric power buses electrically coupling the plurality of power sources to groups of the plurality of electric motors;
a plurality of switches electrically coupled to and between the plurality of power sources and the plurality of electric power buses, the plurality of switches closed during normal operation of the plurality of power sources;
one or more bus tie switches electrically coupled to and between power buses of the plurality of power sources, the one or more bus tie switches open during normal operation of the plurality of power sources; and
power control circuitry configured to open one of the plurality of switches to disconnect a first of the plurality of power sources from a first of the plurality of electric power buses, and close one of the one or more bus tie switches to connect the first of the plurality of electric power buses to a second of the plurality of electric power buses, automatically in direct response to a fault or failure at the first of the plurality of power sources.

7. The vehicle of claim 6, wherein the first of the plurality of electric power buses and the second of the plurality of electric power buses electrically couples the first of the plurality of power sources and a second of the plurality of power sources to respectively first and second groups of the plurality of electric motors, and
wherein the power control circuitry is configured to open the one of the plurality of switches and close the one of the one or more bus tie switches to electrically couple the second of the plurality of power sources to the first and second groups of the plurality of electric motors.

8. The vehicle of claim 1, wherein the power distribution circuitry includes:
a plurality of electric power buses electrically coupling the plurality of power sources to the plurality of electric motors; and
a plurality of source-selection circuitries that are separate and independent, and electrically coupled to and between the plurality of electric power buses and the plurality of electric motors, and
wherein a group of the plurality of source-selection circuitries is configured to switchably connect a first of the plurality of electric power buses and thereby a first of the plurality of power sources to a first group of the plurality of electric motors during normal operation of the first of the plurality of power sources, and a second of the plurality of electric power buses and thereby a second of the plurality of power sources to the first group of the plurality of electric motors automatically in direct response to a fault or failure at the first of the plurality of power sources.

9. The vehicle of claim 8, wherein a second group of the plurality of source-selection circuitries is configured to switchably connect the second of the plurality of electric power buses to a second group of the plurality of electric motors during normal operation of the second of the plurality of power sources, and the first of the plurality of electric power buses to the second group of the plurality of electric motors automatically in direct response to the fault or failure at the second of the plurality of power sources.

10. The vehicle of claim 1, wherein the power distribution circuitry includes:
a plurality of electric power buses electrically coupling the plurality of power sources to the plurality of electric motors;
a plurality of source-selection circuitries that are separate and independent, and electrically coupled to and between the plurality of power sources and the plurality of electric power buses, and
wherein a source-selection circuitry of the plurality of source-selection circuitries is configured to switchably connect a first of the plurality of power sources to a first of the plurality of electric power buses during normal operation of the first of the plurality of power sources, and a second of the plurality of power sources to the first of the plurality of electric power buses automatically in direct response to a fault or failure at the first of the plurality of power sources.

11. The vehicle of claim 10, wherein a second source-selection circuitry of the plurality of source-selection circuitries is configured to switchably connect the second of the plurality of power sources to the second of the plurality of electric power buses during normal operation of the second of the plurality of power sources, and the first of the plurality of power sources to the second of the plurality of electric power buses automatically in direct response to the fault or failure at the second of the plurality of power sources.

12. The vehicle of claim 1, wherein the power distribution circuitry includes:
a plurality of electric power buses with a plurality of feeders electrically coupling the plurality of power sources to the plurality of electric motors; and
a plurality of interlocks electrically coupled to and between the plurality of feeders across the plurality of electric power buses, including interlocks configured to electrically couple feeders of a first of the plurality of electric power buses to different feeders of different ones of others of the plurality of electric power buses, automatically and in direct response to a fault or failure at a first of the plurality of power sources electrically coupled to the first of the plurality of electric power buses.

13. The vehicle of claim 12, wherein the interlocks include switches that are open during normal operation of the plurality of power sources, and the interlocks are configured to close a first of the switches to connect a first feeder of the first of the plurality of electric power buses and one of the feeders of a second of the plurality of electric power buses, and close a second of the switches to connect a second feeder of the first of the plurality of electric power buses and one of the feeders of a third of the plurality of electric power buses.

14. A method of managing power in a vehicle, the method comprising:
providing the vehicle including a plurality of power sources, a propulsion system including a plurality of electric motors configured to power a plurality of propulsors to generate propulsive forces that cause the vehicle to move, and power distribution circuitry; and
delivering direct current (DC) electric power from the plurality of power sources to the plurality of electric motors via the power distribution circuitry electrically coupling the plurality of power sources to the plurality of electric motors in an interleaved topology in which electric motors of the plurality of electric motors are alternately, electrically coupled to power sources of the plurality of power sources, each of the electric motors electrically coupled to a different one of the power sources than immediately adjacent ones of the electric motors.

15. The method of claim 14, wherein delivering the DC electric power includes delivering the DC electric power via the power distribution circuitry in which each of the electric motors is electrically coupled to a different one of the power sources than the immediately adjacent ones of the electric motors in either or both direction of a pitch axis or a roll axis of the vehicle.

16. The method of claim 14, wherein providing the vehicle includes providing the vehicle further including an airframe with a fuselage and one or more pairs of wings that extend from opposing sides of the fuselage, the plurality of electric motors are mounted to the one or more pairs of wings, and each wing has multiple ones of the electric motors mounted to the wing.

17. The method of claim 16, wherein delivering the DC electric power includes delivering the DC electric power via the power distribution circuitry in which the multiple ones of the electric motors include at least a first electric motor and a second electric motor electrically coupled to respectively a first and a second of the power sources.

18. The method of claim 14, wherein the power distribution circuitry includes a plurality of electric power buses electrically coupling the plurality of power sources to groups of the plurality of electric motors, a plurality of switches electrically coupled to and between the plurality of power sources and the plurality of electric power buses, and one or more bus tie switches electrically coupled to and between power buses of the plurality of power sources, the plurality of switches and the one or more bus tie switches respectively closed and open during normal operation of the plurality of power sources, and
wherein the method further comprises opening one of the plurality of switches to disconnect a first of the plurality of power sources from a first of the plurality of electric power buses, and closing one of the one or more bus tie switches to connect the first of the plurality of electric power buses to a second of the plurality of electric power buses, automatically in direct response to a fault or failure at the first of the plurality of power sources.

19. The method of claim 18, wherein the first of the plurality of electric power buses and the second of the plurality of electric power buses electrically couples the first of the plurality of power sources and a second of the plurality of power sources to respectively first and second groups of the plurality of electric motors, and
wherein the one of the plurality of switches is opened, and the one of the one or more bus tie switches is closed, to electrically couple the second of the plurality of power sources to the first and second groups of the plurality of electric motors.

20. The method of claim 14, wherein the power distribution circuitry includes a plurality of electric power buses electrically coupling the plurality of power sources to the plurality of electric motors, and a plurality of source-selection circuitries that are separate and independent, and electrically coupled to and between the plurality of electric power buses and the plurality of electric motors, and
wherein the method further comprises a group of the plurality of source-selection circuitries switchably connecting a first of the plurality of electric power buses and thereby a first of the plurality of power sources to a first group of the plurality of electric motors during normal operation of the first of the plurality of power sources, and a second of the plurality of electric power buses and thereby a second of the plurality of power sources to the first group of the plurality of electric motors automatically in direct response to a fault or failure at the first of the plurality of power sources.

21. The method of claim 20, further comprising a second group of the plurality of source-selection circuitries switchably connecting the second of the plurality of electric power buses to a second group of the plurality of electric motors during normal operation of the second of the plurality of power sources, and the first of the plurality of electric power buses to the second group of the plurality of electric motors automatically in direct response to the fault or failure at the second of the plurality of power sources.

22. The method of claim 14, wherein the power distribution circuitry includes a plurality of electric power buses electrically coupling the plurality of power sources to the plurality of electric motors, and a plurality of source-selection circuitries that are separate and independent, and electrically coupled to and between the plurality of power sources and the plurality of electric power buses, and
wherein the method further comprises a source-selection circuitry of the plurality of source-selection circuitries switchably connecting a first of the plurality of power sources to a first of the plurality of electric power buses during normal operation of the first of the plurality of power sources, and a second of the plurality of power sources to the first of the plurality of electric power buses automatically in direct response to a fault or failure at the first of the plurality of power sources.

23. The method of claim 22, further comprising a second source-selection circuitry of the plurality of source-selection circuitries switchably connecting the second of the plurality of power sources to the second of the plurality of electric power buses during normal operation of the second of the plurality of power sources, and the first of the plurality of power sources to the second of the plurality of electric power buses automatically in direct response to the fault or failure at the second of the plurality of power sources.

24. The method of claim 14, wherein the power distribution circuitry includes a plurality of electric power buses with a plurality of feeders electrically coupling the plurality of power sources to the plurality of electric motors, and a plurality of interlocks electrically coupled to and between the plurality of feeders across the plurality of electric power buses, and
wherein the method further comprises interlocks of the plurality of interlocks electrically coupling feeders of a first of the plurality of electric power buses to different feeders of different ones of others of the plurality of electric power buses, automatically and in direct response to a fault or failure at a first of the plurality of power sources electrically coupled to the first of the plurality of electric power buses.

25. The method of claim 24, wherein the interlocks include switches that are open during normal operation of the plurality of power sources, and
wherein the interlocks electrically coupling the feeders includes the interlocks closing a first of the switches to connect a first feeder of the first of the plurality of electric power buses and one of the feeders of a second of the plurality of electric power buses, and closing a second of the switches to connect a second feeder of the first of the plurality of electric power buses and one of the feeders of a third of the plurality of electric power buses.
